(19) United States
(12) Patent Application Publication
(10) Pub. No.: US 2009/0313534 A1
(43) Pub. Date: Dec. 17, 2009

(54) MULTI MEDIA INTER FACE WITH MULTIMEDIA PRESENTATION

(76) Inventors: Duane Davis, Atlanta, GA (US); Kamau Hunter, Atlanta, GA (US)

Correspondence Address: MICHAEL RIES, 318 PARKER PLACE, OSWEGO, IL, 60543, US

(21) Appl. No.: 12/137,530

(22) Filed: Jun. 11, 2008

(51) Int. Cl. G06F 17/00; G06F 17/30; G06F 15/16; H04L 9/32

(52) U.S. Cl. 715/202; 707/100; 709/206; 726/2; 707/E17.044

(57) ABSTRACT

Multimedia website software and method for creating a multi media inter face with multimedia presentation website. A multimedia website software product may include an installation module and may include a media player to display media uploaded from a site owner to a site visitor, a poll system to present a question and answers to the site visitor, and a feedback system to send comments to the site owner.

### TECHNICAL FIELD AND BACKGROUND

Embodiments of the present invention relate generally to multimedia websites and, more particularly, to multimedia website software to create a multi media inter face with a multimedia presentation.

Embodiments of the present invention include multimedia website software for creating a multimedia website and a flash application inside a browser window that may not have a tool bar and address bar. The multimedia website may be visually appealing and interactive. Embodiments of the present invention enable a site owner to easily create and configure a multimedia website that has a multi media inter face with multimedia presentation that may be accessed using email with links to the multi media inter face with the multimedia presentation.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a schematic representation of a multi media inter face with a multimedia presentation according to one embodiment of the present invention.

FIGS. 2-4 are schematic representations of embodiments of a multi media inter face with a multimedia presentation, according to one embodiment of the present invention.

FIG. 5 is a schematic representation of a control panel according to one embodiment of the present invention.

FIG. 6 is a schematic representation of software interfaces of a multi media inter face with a multimedia presentation according to one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise. The terms “a”, “an” and “the” may refer to one or more than one of an item. The terms “and” and “or” may be used in the conjunctive or disjunctive and will generally be understood to be equivalent to “and/or”. The term “module” may be used to conceptually group related instructions or functions.

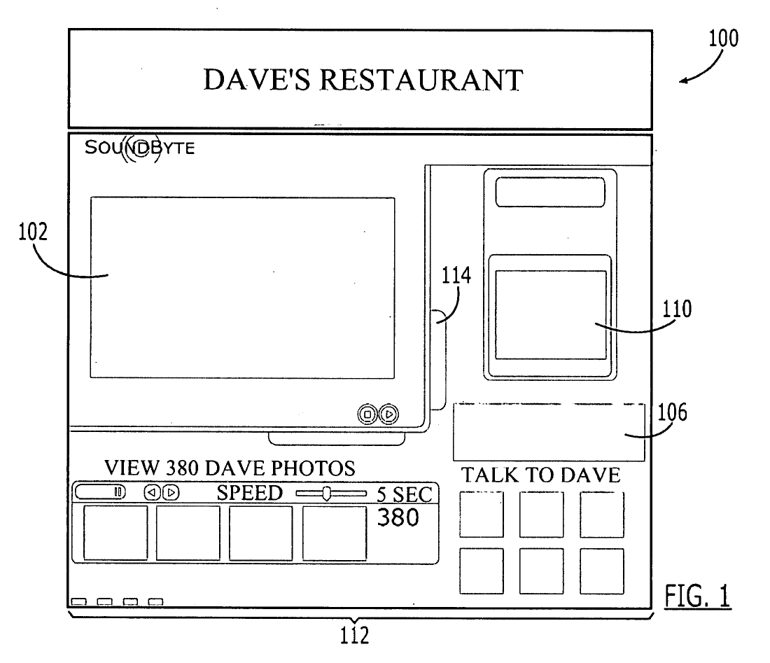

In one embodiment, a multimedia website software may, upon installation, create a multi media inter face with a multimedia presentation by attaching a site owner uploaded media items to a website with an external application. FIG. 1 is a schematic representation of a multi media inter face with multimedia presentation 100 according to one embodiment of the present invention. The multi media inter face with multimedia presentation 100 may include video 102 (or media), IP address targeted information, banner style advertisements 106, a poll system, a location map 110, additional footage 112 (or media), and news 114.

The multimedia website software may be embodied as a PHP script that acts as or in conjunction with an index page of a website. When installed, the PHP script may replace a website index page with a modified index page including an instance of itself all to show the multi media inter face with multimedia presentation. When installed, the PHP script may rename an existing index page so as to preserve the existing index page.

Installation of the multimedia website software may include configuration of a server to recognize the multi media inter face with multimedia presentation 100 as the default web server's index page, configuration of a config.ini.php script (or configuration file), and running of an installation script. Configuration of the config.ini.php script may include configuration of database information, including, not by way of limitation, a host name, a user name, a user password, and a database name. Configuration of the config.ini.php script may include configuration of a uniform resource locator (URL) to the multi media inter face with multimedia presentation 100, and configuration of server information and any other information applicable to the multimedia website software. A site owner may use a text editor to edit fields within a config.ini.php script. A site owner may save and upload the config.ini.php script to a server. Running the multimedia website software install.php script (or installation script) may build all databases and tables.

By navigating to the multi media inter face with multimedia presentation 100, the multimedia website software will run the index PHP script (or multi media inter face with multimedia presentation). The multi media inter face with multimedia presentation 100 may be displayed in a 600×600 pixel browser window. The browser window's toolbar and menu bar may be hidden.

In one embodiment, a screen tag function may be used to open various components, such as a poll system, in an external window in which the toolbar and menu bar may be hidden. Upon selection of a component enabled with a screen tag, a screen tag function may be initiated. The screen tag function may open the component in an external window.

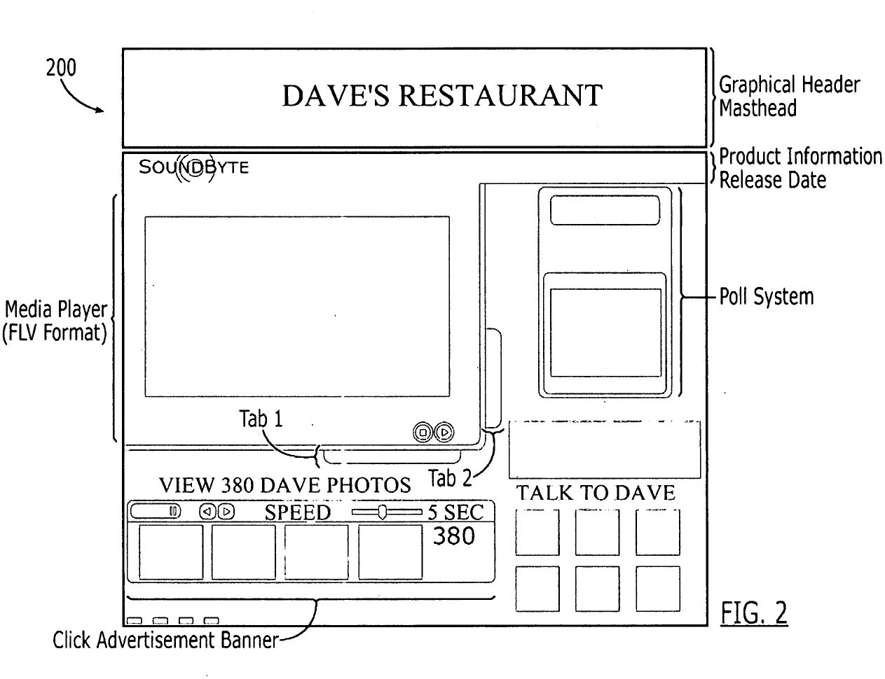

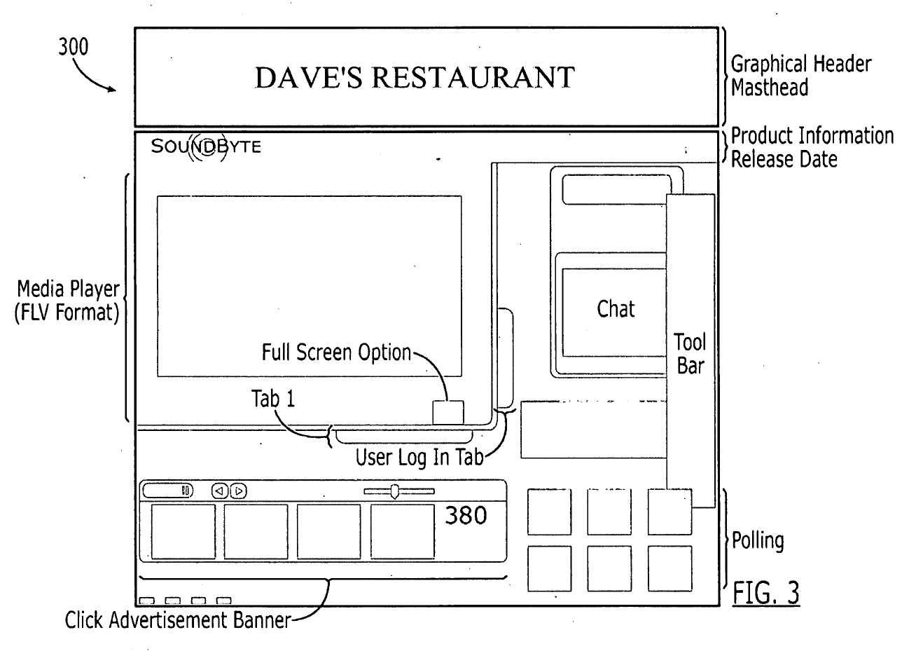

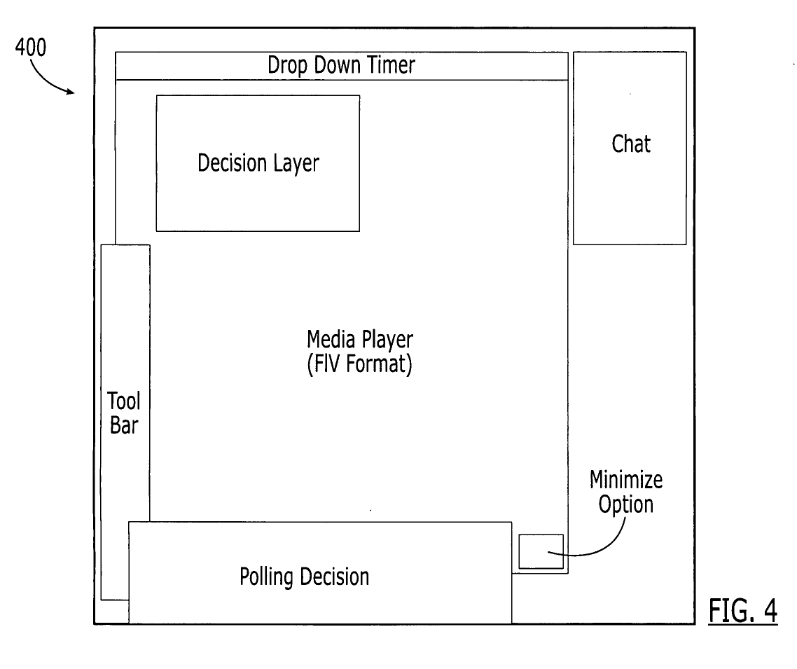

The particular graphical style of the multi media inter face with multimedia presentation 100 may vary depending upon a site owner's needs and preferences. The graphical style may be easily interchangeable. The graphical style may customizable. In this respect, included are FIGS. 2-4 which are schematic representations of embodiments of the multi media inter face with multimedia presentation pages 200, 300, 400, according to embodiments of the present invention.

Critical error messages may be displayed in an alert style box. Such error messages may display the particular error and the possible causes of the error. The alert style box may also include a button to confirm the error. Minimal errors or suggestions may be displayed in a tooltip component.

The index PHP script may display to a user (or visitor), video 102 (or other media) uploaded by a site owner. In one embodiment, video 102 may be displayed using a Flash ( (a registered trademark of Adobe Systems Incorporated, San Jose, Calif.) player (or other media player). The index PHP script may timeout after the video content has been completely presented or after a predetermined elapsed time. The multi media inter face with multimedia presentation 100 may include a decision layer. The decision layer may be positioned overtop of the Flash player. The decision layer may function to allow a user to interact with a video. Interaction may be as simple as a poll using radio buttons or as complex as video game like simulation. Games may be developed on other platforms and are not limited to Flash. Upon initialization of the multi media inter face with multimedia presentation 100, calls may be made to decision layer scripts to initialize the decision layer. A cue from the Flash player may initialize an instance of the decision layer.

The multi media inter face with multimedia presentation 100 may include player attributes system. The player attributes system may include a collection of tools that may allow a user to interact with enhanced video aspects of the multi media inter face with multimedia presentation. The player attributes system may enhance user game play. Upon initialization of the multi media inter face with multimedia presentation 100, calls may be made to player attributes scripts to initialize the player attributes system. Clicking on a tool on a player attribute tool bar may initialize an instance of the tool selected.

The tools on the player attributes tool bar may include, not by way of limitation, zoom in, split, scratch, slide, slow motion, and mach. The zoom in tool may allow a user to zoom in, around and away from items on a video at designated times in enhanced video areas. The split tool may allow a user to split the screen horizontally and allow a user to view the video from other perspectives. The scratch tool may allow a user to mouse-over areas of an enhanced video and reveal items. The slide tool may work with the split tool and allow a user to accomplish a picture-in-picture effect. The slow motion tool may allow a user to slow down playback of enhanced video areas. The mach tool may allow a user to speedup playback of enhanced video areas. The Flash player may include multiple controls and displays, including, not by way of limitation, seek back, seek forward, stop, pause, play, buffer bar, and volume control. The seek back control may move video playback back a predetermined amount. The seek forward control may move video playback forward a predetermined amount. The pause control may pause video playback. The stop control may stop play of video playback. The volume control may control the volume level of the video's audio. The video buffer may display a buffer position of a video.

The Flash player may be able to read a playlist in Extensible Mark-up Language (XML) format. The Flash player may have a function to allow a user to switch between the player and an additional footage 112 panel. The Flash player may have a function to display footage titles in the additional footage 112 panel. The Flash player may have a function to support RSS 2.0. The Flash player may have a function to customize the player's skin.

The multi media inter face with multimedia presentation 100 may include an IP address track feature. The IP address track feature may be used to determine a user machine's location and to display appropriate content, the appropriate content may be local ad campaigns to the tracked IP address. For example once the IP address is tracked then the multi media inter face with multimedia presentation can be modified to show local ads, local coupons or the like all connected to the tracked IP address.

The multi media inter face with multimedia presentation 100 may include a poll system. A site owner may create polls including a question and a series of answers. A site owner may view the results of the polls. The poll system may query a database to see if there are any questions. The poll system may display questions and answers. Answers may have associated radio buttons. Clicking a radio button may select an answer. Clicking a vote button may transmit that answer to a poll script. The poll script may send results back and display those results. When the multi media inter face with multimedia presentation is initiated, calls may be made to polling scripts. The calling multi media inter face with multimedia presentation may receive data from the polling scripts to build the poll. When a user clicks on a poll answer radio button and clicks submit, the polling system may insert the data into the mySQL database.

The multi media inter face with multimedia presentation 100 may include an additional footage (or media) section. The additional media section may display selectable thumbnail images of media that can be viewed as video 102 (or media). Selecting a thumbnail image may enable an additional media actionscript function. The additional media actionscript may call the additional media scripts. The additional media actionscript may send the appropriate FLV path to the calling application function. The additional media actionscript may send the path to the Flash player and the Flash player may play the FLV file.

The multi media inter face with multimedia presentation 100 may include a feedback system. The feedback system may function as a system to send comments to a site owner. The system may allow a user to submit a formatted message to the system which may be stored in the mySQL database. The site owner may have a function to retrieve and view stored messages. Upon initiation of the multi media inter face with multimedia presentation 100, calls may be made to feedback system scripts to build the feedback system. Clicking comment box or tab once may call an actionscipt function to enable a comment panel. Clicking comment box or tab a second time may close the comment panel. The feedback system may use an actionscipt tween function to tween the comments panel on the y-axis. The comment panel by default may display two buttons; post comment, and view comments. The buttons may toggle between the post comment panel and the view comment panel. The post comment panel may include multiple input fields, including, not by way of limitation, email address, subject, and comment. Clicking on a submit button may call comments scripts. The comments scripts may retrieve data from a calling application and may insert the data into the mySQL database. Clicking the view comment panel button may enable a view panel actionscript function. The view panel function may make calls to the comments scripts. The comments scripts may retrieve data from the mySQL database and send the data back to the calling application. The view comments panel function may display a date in a row format.

The feedback system may have a function to initialize the feedback system. The feedback system may have a button to open the feedback panel. The feedback system may have a function to input text in the appropriate fields. The feedback system may have a function to validate the text that has been inputted. The feedback system may have a function to submit an inputted date into the mySQL database.

The feedback system 100 may include a news feed system. The news feed system may make calls to news feed scripts. The news feed scripts may retrieve data from a mySQL database and send data to the calling application. The news feed system may use the data received to populate a news feed panel. Each news feed may include an image, description and link to a full article. Clicking a news feed item may enable a javascript function that may open the feed in a new window.

In one embodiment, the news feed system may function to view RSS feeds related to the site owner's content. Upon initialization of the feedback system 100, calls may be made to news feed system scripts to build the news system. Clicking the news box or tab once may call an actionscript function to enable the news feed system. Clicking the news box or tab a second time may close the news feed panel. The news feed system may use an actionscript tween function to tween the news panel on the x-axis. The news feed system may make calls to news feed scripts.

The multi media inter face with multimedia presentation 100 may include a banner ad system. The banner ad system may function to deliver banner type advertisements on the multi media inter face with multimedia presentation 100. When the multi media inter face with multimedia presentation is initialized, calls may be made to banner ad scripts to place the banner ad in a predetermined location. Clicking a banner ad may open a page associated with the advertisement in an external window. The banner ad system may have a function to initialize the banner ad system. The banner ad system may have a button to open the banner in an external window. The multi media inter face with multimedia presentation 100 may include a mapping system. The mapping system may deliver maps on the multi media inter face with multimedia presentation. When the multi media inter face with multimedia presentation is initialized, calls may be made to map scripts to place a map in a predetermined location. Clicking on the map may open the map in an external window. The mapping system may have a function to initialize the mapping system.

The multi media inter face with multimedia presentation 100 may include a timer. The timer may gage the amount of time a user has to interact with a video or decision making process. The timer may monitor the time a user has and may keep video flow consistent. When the multi media inter face with multimedia presentation is initialized, calls may be made to timer scripts to initialize the timer. A cue from the Flash player may initialize a new timer instance.

The multi media inter face with multimedia presentation 100 may include a chat system. The chat system may allow users logged in to chat amongst one another. When the multi media inter face with multimedia presentation is initialized, calls may be made to chat scripts to initialize the chat system. Typing a message into a chat input box may display the text in the input box. Clicking a send button may submit the text to the chat system.

The multi media inter face with multimedia presentation 100 may include a login system. The login system may validate a user and grant them member privileges to the multi media inter face with multimedia presentation 100. When the multi media inter face with multimedia presentation 100 is initialized, calls may be made to login scripts to initialize the login system. Typing text into the input areas may display text in the area. If the input is a password box, the display may contain asterisks. Clicking login may submit the text to a login function. If the login information is correct, the user may be granted member privileges. Otherwise, the user may be rejected.

The multi media inter face with multimedia presentation 100 may include distractions tools. The distractions tools are tools that may allow users to target and interact with another user's multi media inter face with multimedia presentation. Clicking on a distraction icon may initialize a distraction system.

The multi media inter face with multimedia presentation may include a decision buffer. The decision buffer may function as a graphic or video sequence that may distract the user while polls are being processed. A cue from a decision layer may initiate a decision buffer.

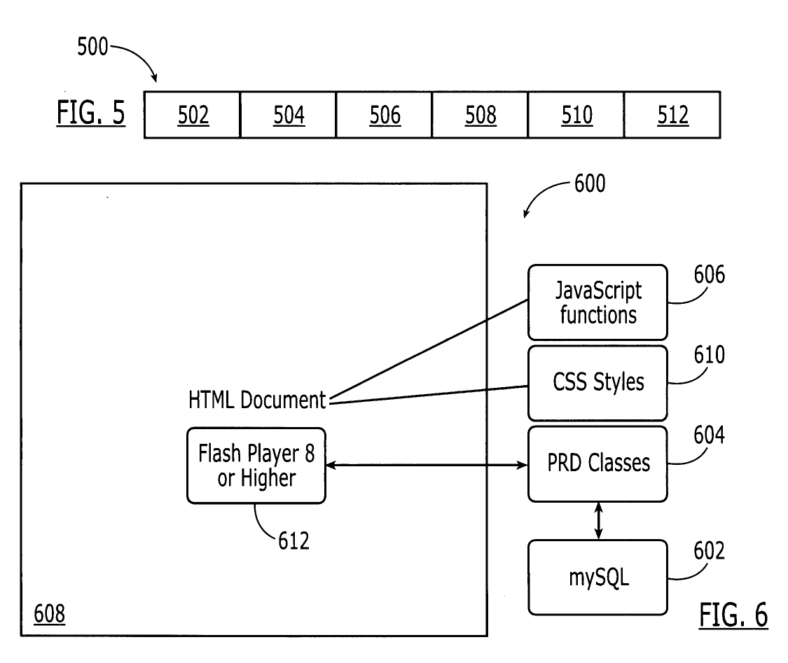

The multimedia website software may include a control panel. FIG. 5 is a schematic representation of a control panel 500 according to one embodiment of the present invention. The control panel 500 may comprise a Flash based control panel. The control panel 500 may allow a site owner to moderate the installation of their instance of a multi media inter face with multimedia presentation. The control panel 500 may include a variety of selections, including, not by way of limitation, an upload video (or media) selection 502, an IP address tracking selection 504, a timeout selection 506, a poll system selection 508, an additional media selection 510, and a news feed selection 512.

Upon selecting the upload video selection 502, a function may be initiated to upload video (or media) content. The function may allow a site owner to navigate their computer's file system and select a file to upload. Clicking an upload selection may initiate the upload. When the upload is completed, the site owner may be given a notification.

Upon selecting the IP address tracking section 504, a site owner may upload multiple video files. A site owner may associate a zip code with each uploaded video file. Clicking a submit selection may insert the data into the database. Upon selecting the timeout section 506, a site owner may be promoted to input an amount of seconds after which the multi media inter face with multimedia presentation may timeout. Clicking a submit selection may insert the data into the database. Upon selecting the poll system section 508, a site owner may be navigated to a polls panel. The polls panel may enable a user to select a current polls selection to generate a list of the current polls on the system. For each poll, a site owner may have a variety of selections, including, not by way of limitation, voting stats, edit, delete, and create poll.

Upon selecting voting stats, information including total votes, today's votes, and answers votes may be displayed. Total votes may display the amount of votes a poll has received. Today's votes may display the amount of votes received that day. Answers votes may display a list of a poll's questions. Each question may have the percentage and the number of votes the poll received.

Upon selecting edit from the polls panel, a create poll form may be generated. Editing may retrieve a poll's data from the mySQL database and fill in the fields of the create poll form with that poll's appropriate content. Upon selecting save poll, the updated data may be inserted into the mySQL database. Upon selecting delete, a site owner may be prompted for a confirmation. Upon confirmation, a poll may be deleted from a mySQL database.

Upon selecting create poll, a form may be generated with multiple fields or selections, including, not by way of limitation, enter poll question, enter poll answers, vote limit, show results as, on vote show, and save. The enter poll question field may allow input of a poll question. The enter poll answers field may allow input of answers to a poll question. This field may comprise ten fields. The vote limit field may allow input of a number of times a user may vote. The show results as field may allow input of the formatting in which results may be viewed. For example, results may be viewed as a number, percentage, number and percentage, or a informative dialog such as no results. The on vote show field may allow input of action to be taken after a poll is conducted. For example, actions may include doing nothing or displaying total votes. Upon selecting the save selection, a poll may be saved in the mySQL database. The additional media selection 510 may, as discussed above with respect to the additional footage section, display selectable thumbnail images of media that can be viewed in the Flash video player.

Upon selecting the news feed selection 512, a site owner may be navigated to a news feed panel. The news feed panel may have a function to allow a site owner to create news feeds. The news feed panel may have a variety of selections, including, not by way of limitation, upload thumbnail, news feed description, target link, edit feed, change thumbnail, update description, update target link, delete feed, and view feed. Upon selecting the upload thumbnail selection, a site owner may be allowed to navigate their computer's file system. Clicking select may invoke the uploading process. Upon selecting the news feed description selection, a site owner may be allowed to enter a news feed description. The news feed description may be limited to 255 characters in a text field. Clicking submit may insert the newsfeed description into a mySQL database. Upon selecting the target selection, a site owner may insert a target link into a mySQL database. Upon selecting the edit feed selection, a site owner may be navigated to an edit feed panel. The edit feed panel may display a list of the current news feeds saved in the mySQL database. A radio button may be associated with each feed. Upon selecting the radio button, that news feed may be selected and a site owner may be navigated to the updating panel. The updating panel may display multiple options, including, not by way of limitation, change thumbnail, update description, update target link, delete feed, and view feed.

Upon selecting the change thumbnail selection, a function may be invoked allowing the site owner to navigate their computer's file system. Selecting a file to may initiate an uploading process. The site owner may be prompted to confirm the change. Selecting confirm change may invoke a process to insert the file into the mySQL database.

Upon selecting the update description selection, a function may be invoked allowing editing of description text. Clicking submit may invoke a function to insert the update into the mySQL database. Upon selecting the update target link selection, a function may be invoked to input a new target link. Clicking submit may invoke a function to insert the update into the mySQL database.

Upon selecting the delete feed selection, a list of news feeds in the system may be generated. A radio button may be associated with each news feed. Clicking the radio button may prompt the site owner for confirmation. Upon confirmation, the news feed may be deleted from the mySQL database. Upon selecting view feed selection, a list of news feeds in the system may be generated. A radio button may be associated with each news feed. Clicking the radio button may display the associated news feed.

FIG. 6 is a schematic representation of software interfaces 600 of a multi media inter face with multimedia presentation according to one embodiment of the present invention. The software interfaces may include a database management system 602, such as mySQL, a server-side scripting language 604, such as PHP, client-side scripting languages 606, such as javascript, HTML 608, CSS 610, and a Flash player 612.

While the present invention has been related in terms of the foregoing embodiments, those skilled in the art will recognize that the invention is not limited to the embodiments described. The present invention can be practiced with modification and alteration within the spirit and scope of the appended claims and their equivalents. Thus, the description is to be regarded as illustrative instead of restrictive on the present invention.

What is claimed is:

1. A multimedia website software product, comprising:
an installation module to install a multi media inter face with multimedia presentation, the multi media inter face with multimedia presentation comprising:
a media player to display media uploaded from a site owner to a site visitor;
a poll system to present a question and answers to the site visitor; and
a feedback system to send comments to the site owner.

2. The multimedia website software product of claim 1, wherein the multi media inter face with multimedia presentation is hypertext markup language based and includes a PHP script.

3. The multimedia website software product of claim 1, wherein the media player to display media uploaded from a site owner to a site visitor comprises a Flash media player.

4. The multimedia website software product of claim 1, further comprising a database to store data called by at least one of the media player, the poll system and the feedback system.

5. The multimedia website software product of claim 4, wherein the database to store data called by the at least one of the media player, the poll system and the feedback system comprises a mySQL database.

6. The multimedia website software product of claim 1, wherein the installation module comprises an installation script to rename an existing index webpage to preserve that existing index webpage.

7. The multimedia website software product of claim 1, wherein the multi media inter face with multimedia presentation further comprises a timer to time media delivery.

8. The multimedia website software product of claim 1, wherein the multi media inter face with multimedia presentation further comprises a decision layer to allow the site visitor to interact with media.

9. The multimedia website software product of claim 1, further comprising a login system to allow login by at least one of the site owner and the site visitor.

10. The multimedia website software product of claim 1, further comprising a control panel to allow a site owner to moderate installation of an instance of multi media inter face with multimedia presentation.

11. The multimedia website software product of claim 1, wherein multi media inter face with multimedia presentation further comprises a decision buffer to distract the site visitor during processing by the poll system.

12. A multi media inter face with multimedia presentation, comprising:
a video player to display a video uploaded from a site owner to a site visitor;
a poll system to present a question and answers to the site visitor; and
a feedback system to send comments from the site visitor to the site owner.

13. The multi media inter face with multimedia presentation of claim 12, wherein the multi media inter face with multimedia presentation is hypertext markup language based and includes a PHP script.

14. The multi media inter face with multimedia presentation of claim 13, wherein the PHP script calls to a remote server.

15. The multi media inter face with multimedia presentation of claim 12, wherein a user interface of the multi media inter face with multimedia presentation is interchangeable.

16. The multi media inter face with multimedia presentation of claim 12, wherein a user interface of the multi media inter face with multimedia presentation is customizable.

17. A method of enabling installation of a multi media inter face with multimedia presentation, comprising:
providing software to install the multi media inter face with multimedia presentation;
wherein the multi media inter face with multimedia presentation comprises:
a media player to display media uploaded from a site owner to a site visitor;
a poll system to present a question and answers to the site visitor; and
a feedback system to send comments to the site owner.
